(19) United States
(12) Patent Application Publication
(10) Pub. No.: US 2003/0002088 A1
(43) Pub. Date: Jan. 2, 2003

(54) Method for enhancing image output quality employing product data included on an image bearing media

(76) Inventor: James E. O'Hara, Boise, ID (US)

Correspondence Address: HEWLETT-PACKARD COMPANY, Intellectual Property Administration, P. O. Box 272400, Port Collins, CO, 80527-2400, US

(21) Appl. No.: 09/894,726

(22) Filed: Jun. 27, 2001

(51) Int. Cl. H04N 1/04

(52) U.S. Cl. 358/474

(57) ABSTRACT

A method for enhancing image output quality including the steps of scanning a first side of an image bearing media to acquire data representative of a first side image and scanning a second side of the image bearing media to acquire product data. A processing device is operable in connection with the scanning device and utilizes product data in processing first side image data to enhance the quality of the image data output. Product data may include any data that relates to manufacture of the image bearing media including the identity of the manufacturer of the media, the source of the media or properties of the media itself including the dye set employed by any given manufacturer.

### FIELD OF THE INVENTION

The present invention relates generally to image data processing and more specifically to a method for enhancing image output quality by scanning a second side of an image bearing media to acquire data relating to the manufacture of the image bearing media.

### BACKGROUND OF THE INVENTION

Optical scanning and copying devices employ a method wherein data representative of a scanned object is produced by projecting an image of the scanned object onto an optical sensor. An image of the scanned object is projected onto an optical sensor by linear increment employing a moving scan line. The moving scan line is produced either by moving an image bearing media with respect to the scanner optical assembly or by moving the scanner optical assembly relative to an image bearing media. The optical sensor produces data representative of the intensity of the light projected thereon, i.e. data representative of the scanned image. Such stored data may be processed by a processing device to produce an image output or display. When photographic media is scanned to produce data representative of an image formed on that photographic media, the data may be further processed for output by an processing device.

Scanning devices may include a media input, a media transport and a media feed path for transporting documents to a scan position, such as a flatbed platen, or across a scanline. Optical scanning devices also include an imaging assembly including an array of photosensitive sensors, operable in successive sampling intervals for generating a plurality of linear samplings producing image data representative of the object being scanned. Scanning devices are known that include both one or two imaging assemblies. In the case of a scanning device including a single imaging assembly, a single side of an object may be scanned at a time. In the case of a scanning device including a pair of imaging assemblies, both sides of an object may be scanned simultaneously. A document including images on both the first and second sides may be scanned simultaneously while being advanced through a scan position by the media transport.

Manufacturers of various image bearing media or media for image reproduction may include product data, that is information that relates to the identity of the manufacturer of the media, the source of the media or properties of the media itself including the manufacturer's dye set. There may be advantage in providing a method for scanning an image bearing media to acquire product data, the product data being utilized by a processing device to enhance image data for output.

### SUMMARY OF THE INVENTION

The present invention is directed to a method for enhancing image output quality including the steps of scanning a first side of an image bearing media for acquiring data representative of a first side image and scanning a second side of the image bearing media to acquire specified or product data, that is data relating to manufacture of the image bearing media. Particularly, product data may include any information relating to manufacture of the image bearing media identity including the identity of the manufacturer of the media, the source of the media or properties of the media itself including the dye set employed by any given manufacturer. Product information may include any information that directly or indirectly relates to the media that may be utilized to affect processing of image data. For instance, information may indirectly relate to the dye set employed by any given manufacturer to the extent that a manufacturer places any identifying information on the second side of the image bearing media. A processing device may reference a library of manufacturer product data to determine media properties and characteristics including the dye set employed by any given manufacturer. Alternately, information may be obtained that directly relates to the dye set employed by any given manufacturer to the extent that a manufacturer may include such information on the second side of the image bearing media. Regardless of the manner in which product data is obtained, the information, once obtained is utilized by a processing device to provide image enhancement and to optimize output image quality.

In one preferred embodiment of the invention, a document including images on both the first and second sides is scanned, both sides in a substantially simultaneous scanning interval while being advanced through a scan position by the media transport. A pair of imaging assemblies are arranged adjacent to and on either side of the document path. The pair of imaging assemblies are arranged such that documents bearing an image on one or both sides may be transported along a sheet path permitting scanning and data acquisition from both sides of the document in a substantially simultaneous time frame or interval. The first imaging assembly produces data representative of the media first side scanned image and the second imaging assembly produces data representative of the media second side scanned image, including any product data.

The scanning device and method of the present invention provides image data processing which may enhance the quality of a reproduction of an image by obtaining product data and employing such information, including the dye set employed by any given manufacturer, to enhance image data. The scanning device and method of the present invention may also provide an image processing which may enhance the accuracy of color reproduction of a film image by obtaining product data and employing such information, including the dye set employed by any given manufacturer, to enhance image data.

### DESCRIPTION OF THE DRAWINGS

FIG. 1 is a schematic diagram illustrating the method for enhancing image output quality according to the present invention;

FIG. 2 is a side cutaway view of a duplex scanning device including an automatic document feeder;

FIG. 3 is a side cutaway view of a duplex imaging assembly;

FIG. 4 is a block diagram illustrating a scanning device according to the present invention; and

FIG. 5 is a flow chart depicting the steps of a method for enhancing image output quality according to the present invention.

### DETAILED DESCRIPTION OF THE INVENTION

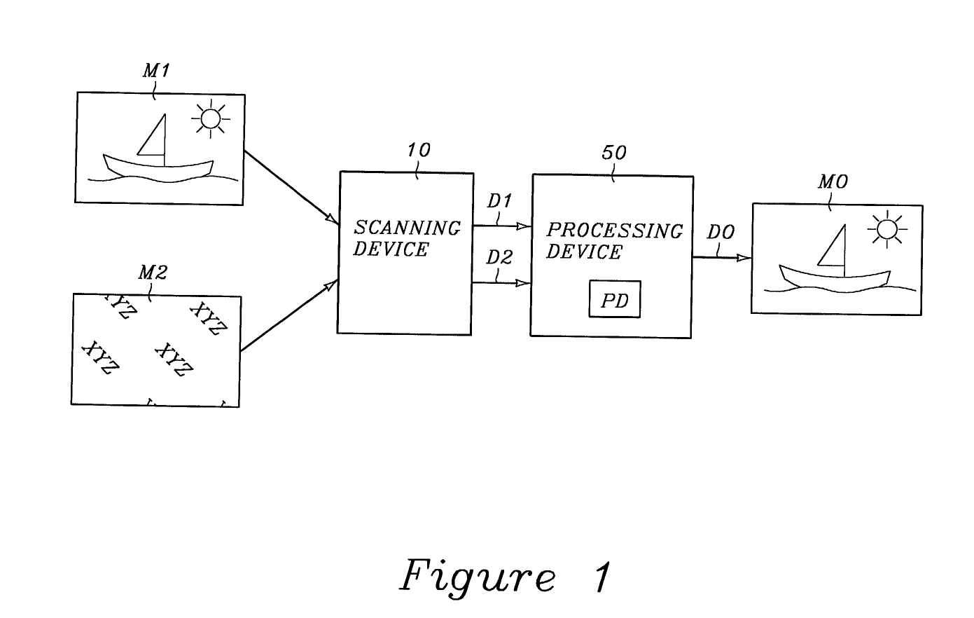

FIG. 1 is a schematic diagram illustrating a method for enhancing image output quality according to the present invention. Media first side Ml and media second side M2 each include an image which is scanned by scanning device 10. Scanning media first side Ml produces first side image data Dl and scanning media second side M2 produces second side image data D2. Second side image data D2 may comprise in part product data PD which may be obtained or derived from second side image data D2. Processing device 50 queries second side image data D2 to determine if second side image data D2 comprises product data PD. If second side image data D2 includes product data PD, then the product data PD is employed by processing device 50 to process and enhance first side image data Dl.

Output data DO may be employed to produce output media MO. Alternately output data DO may be stored or output by other means for example video output.

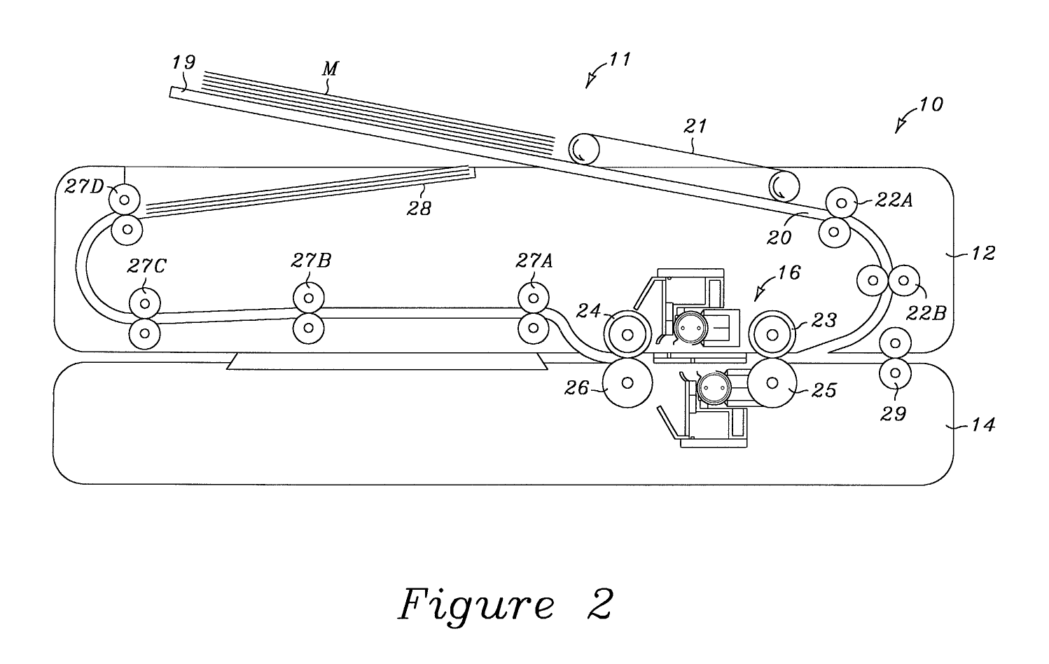

FIG. 2 is a side cutaway view of a duplex scanning device 10 including upper frame member 12 and lower frame member 14. Duplex scanning device 10 includes automatic document feeder 11 having input feed mechanism 21. Media M for processing are positioned in input tray 19. Input feed mechanism 21 transports media M along sheet transport path 20 where it is picked up by input feed rollers 22A and 22B. Alternately, media M may enter sheet transport path 20 at inline feed rollers 29. Sheet transport path 20 continues through duplex imaging assembly 16 by operation of first drive roll 23, second drive roll 24, first idler roll 25 and second idler roll 26.

Following scanning by duplex imaging assembly 16, media M continues along sheet transport path 20 and is picked up and transported by output feed rollers 27A, 27B, 27C and 27D to output tray 28.

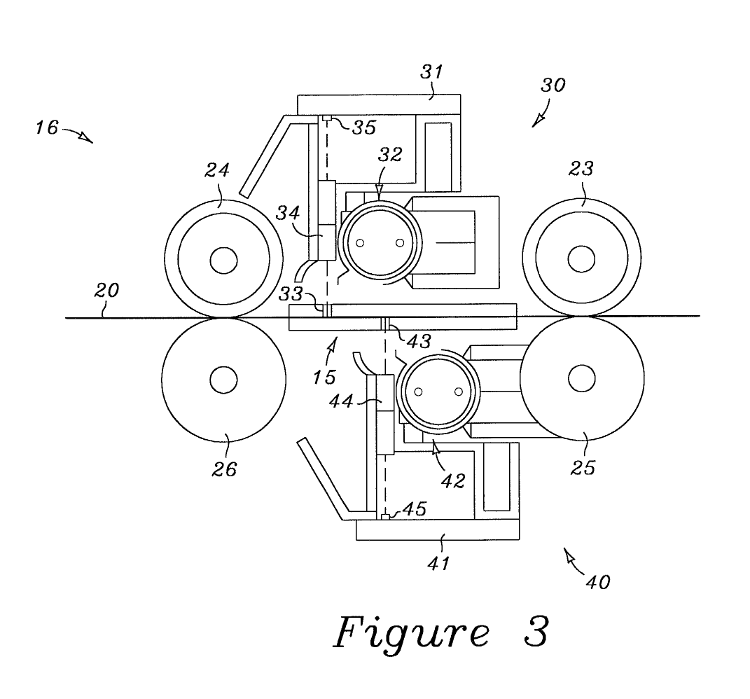

FIG. 3 is a side cutaway view of duplex imaging assembly 16. Sheet transport path 20 continues through duplex imaging assembly 16 by operation of first drive roll 23, second drive roll 24, first idler roll 25 and second idler roll 26. A first side of media M is scanned at scan location 15 by upper imaging assembly 30 and a second side of media M is scanned by lower imaging assembly 40.

Upper imaging assembly 30 includes upper imaging assembly frame 31 which supports upper lamp assembly 32 for illuminating a media first side scanline. Upper aperture 33 provides a light path for light reflected from the first side of media M through upper lens 34 to upper photosensor 35. Data representative of the intensity of light which is reflected by the illuminated first side of media M is generated by upper photosensor 35. Similarly, lower imaging assembly 40 includes lower imaging assembly frame 41 which supports lower lamp assembly 42 for illuminating a media second side scanline. Lower aperture 43 provides a light path for light reflected from the media second side scanline through lower lens 44 to lower photosensor 45. Data representative of the intensity of light which is reflected by the illuminated first side of media M is generated by lower photosensor 45.

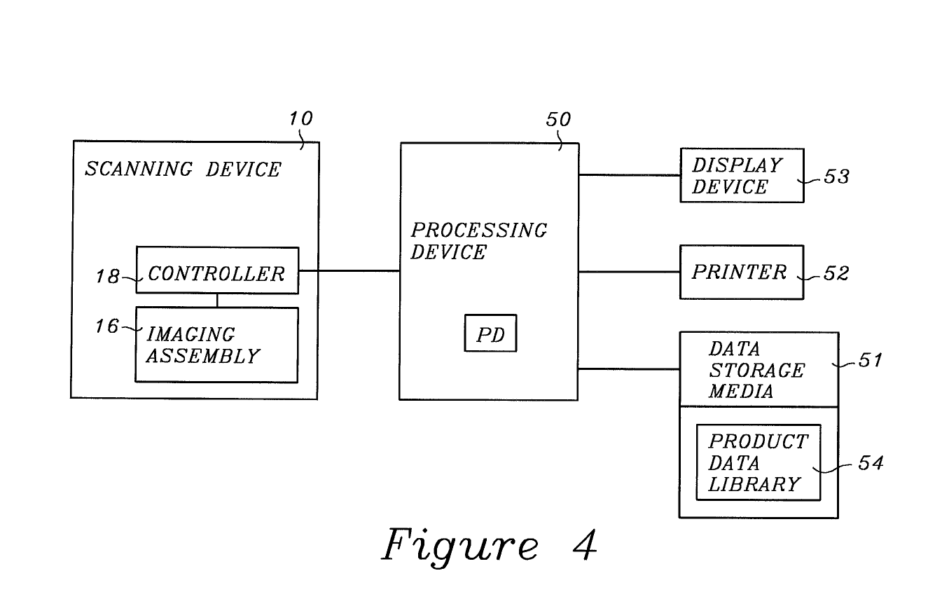

FIG. 4 is a block diagram illustrating a scanning device according to the present invention. As seen in FIG. 4, optical scanning device 10 may also include or may be connected to a processing device 50, for example a personal computer, for processing data from upper photosensor 35 and lower photosensor 45. One arrangement includes scanning device 10 including imaging assembly 16 connected to controller 18, controller 18 connected to processing device 50. Processing device 50 is connected to controller 18, data storage media 51, printer 52 and video display 53. Data storage media 51 may include a product data library 54. Processing device 50 may reference product data library 54 which comprises data relating to media properties and characteristics including the dye set employed by any given manufacturer.

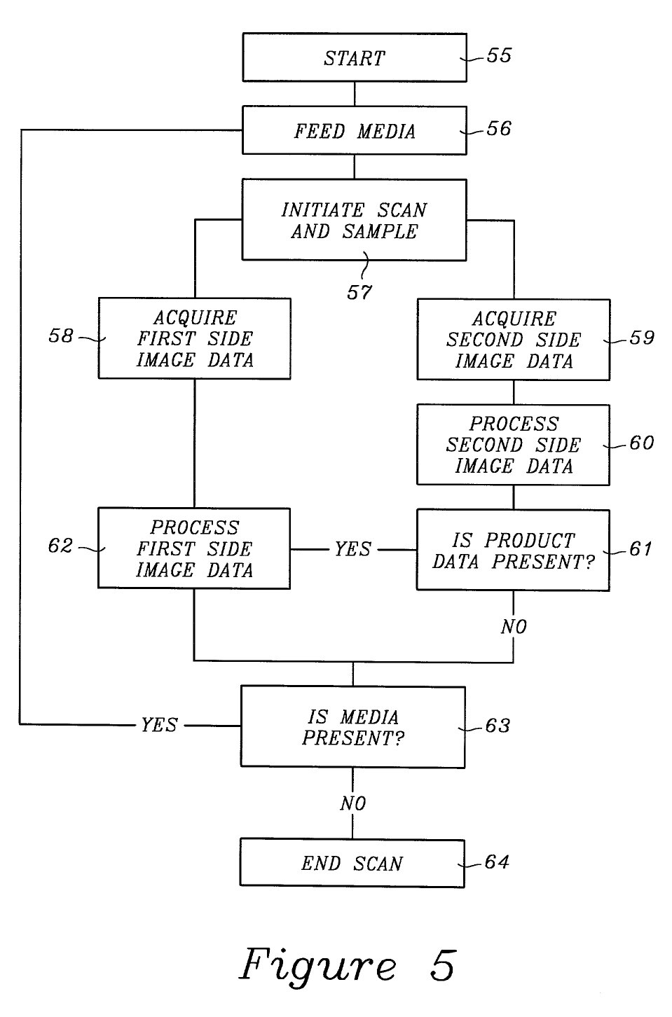

FIG. 5 is a flow chart depicting the steps of enhancing image output quality by means of the present invention. The process is initiated at START 55. Media is fed by automatic document feeder 11, (shown in FIG. 2), at FEED MEDIA 56. Controller 18, (shown in FIG. 4), senses the presence of media and signals upper imaging assembly 30 and lower imaging assembly 40, (shown in FIG. 3), to initiate the scanning and sampling process at INITIATE SCAN AND SAMPLE 57. Upper photosensor 35, (shown in FIG. 3), acquires data representative of light reflected by the media first side at ACQUIRE FIRST SIDE IMAGE DATA 58. Similarly, lower photosensor 45, (shown in FIG. 3), acquires data representative of light reflected by the media second side at ACQUIRE SECOND SIDE IMAGE DATA 59. Second side image data D2, (shown in FIG. 1), is processed by processing device 50 at PROCESS SECOND SIDE IMAGE DATA 60 and queries to determine if the second side image data D2 comprises product data PD at IS PRODUCT DAT PRESENT? 61. If the answer is YES then the product data PD is employed by processing device 50 to process and enhance first side image data Dl at PROCESS FIRST SIDE IMAGE DATA 62. Following processing of first side image data the process queries whether or not additional media is present at IS MEDIA PRESENT? 63. If media is present as indicated at YES, the process returns to FEED MEDIA at 56. If media is not present, as indicated at NO, the process ends the scan operation at END SCAN 64.

While this invention has been described with reference to the detailed embodiments, this is not meant to be construed in a limiting sense. Various modifications to the described embodiments, as well as additional embodiments of the invention, will be apparent to persons skilled in the art upon reference to this description. It is therefore contemplated that the appended claims will cover any such modifications or embodiments as fall within the true scope of the invention.

What is claimed is:

1. An optical scanning device for producing machine-readable data representative of an image bearing media comprising:
a scanner controller;
a transport assembly connected to the scanner controller for moving the image bearing media relative to a scanline;
a first imaging assembly connected to the scanner controller and operable for generating first side image data representative of a first side image;
a second imaging assembly connected to the scanner controller and operable for generating product data; and
a processing device responsive to the product data for enhancing image output quality.

2. The optical scanning device of claim 1 wherein the image bearing media includes photographic print sheet media.

3. The optical scanning device of claim 1 wherein the product data includes information relating to an image bearing media manufacturer.

4. The optical scanning device of claim 1 wherein the product data includes information relating to an image bearing media property.

5. The optical scanning device of claim 1 wherein the product data includes information relating to an image bearing media dye set.

6. The optical scanning device of claim 1 wherein the product data is derived indirectly from image data acquired by scanning the second side of the image bearing media.

7. The optical scanning device of claim 1 wherein the product data is obtained directly from image data generated by scanning the second side of the image bearing media.

8. The optical scanning device of claim 1 further comprising a library of manufacturer product data readable by the processing device for determining media properties.

9. The optical scanning device of claim 1 further comprising a library of manufacturer product data readable by the processing device for determining a dye set employed by a manufacturer.

10. An image data processing method for enhancing image output quality including the steps of:
scanning a first side of an image bearing media to acquire first side image data representative of a first side image;
scanning a second side of the image bearing media to acquire product data; and
processing the data representative of the first side image utilizing the product data to enhance image output quality.
